(19) United States
(12) Patent Application Publication
(10) Pub. No.: US 2014/0279748 A1
(43) Pub. Date: Sep. 18, 2014

(54) METHOD AND PROGRAM STRUCTURE FOR MACHINE LEARNING

(71) Applicant: Georges Harik, Palo Alto, CA (US)

(72) Inventor: Georges Harik, Palo Alto, CA (US)

(73) Assignee: Georges Harik, Palo Alto, CA (US)

(21) Appl. No.: 14/203,277

(22) Filed: Mar. 10, 2014

Related U.S. Application Data
(60) Provisional application No. 61/798,668, filed on Mar. 15, 2013.

(51) Int. Cl. G06N 99/00

(52) U.S. Cl. CPC G06N 99/005
USPC 706/12

(57) ABSTRACT

A method using a recognizer program structure is used in a program that is learned over training data. The method includes (a) for each vector in an input tuple of vectors, (i) mapping the vector to one of a domain index; (ii) using the domain index to select one or more corresponding linear transformations; (iii) applying one or more of the selected linear transformations on the vector to obtain a resulting vector in a first intermediate space; and (iv) applying a predetermined function on each element of the resulting vector to obtain an output vector in a second intermediate space; and (b) mapping the resulting vectors of the second intermediate space by linear transformation to obtain an output tuple of vectors in R^{N} space.

### CROSS-REFERENCE TO RELATED PATENT APPLICATIONS

The present application is related to and claims priority of U.S. provisional patent application (“Copending Provisional Application”), Ser. No. 61/798,668, filed on Mar. 15, 2013. The present application is also related to (i) U.S. provisional patent application (“Related Provisional Application”), Ser. No. 61/776,628, entitled “METHOD AND PROGRAM STRUCTURE FOR MACHINE LEARNING,” filed on Mar. 11, 2013, and (ii) U.S. patent application (“Related Application”), Ser. No. ______, entitled “METHOD AND PROGRAM STRUCTURE FOR MACHINE LEARNING,” filed on Mar. ______, 2014. The disclosures of the Copending Provisional Application, the Related Provisional Application and the Related Application are hereby incorporated by reference in their entireties.

### BACKGROUND OF THE INVENTION

1. Field of the Invention

The present invention relates to programs that acquire their capability by a learning process using training data. In particular, the present invention relates to methods and program structures that can be used to construct programs that can be trained by such a learning process.

2. Discussion of the Related Art

Learning problems are often posed as problems to be solved by optimizing, minimizing or maximizing specific parameters of a particular program. While many methods have been developed to solve these kinds of problems, including local methods (e.g., derivative-based methods) and global methods, less attention is paid to the particular structures of the programs that solve such problems.

### SUMMARY

According to one embodiment of the present invention, a method is provided in a recognizer program structure used in a program that is learned over training data. In that embodiment, the recognizer program structure receives an input tuple of vectors in R^{N} space, N being an integer. The method includes (a) for each vector in the input tuple of vectors, (i) mapping the vector to one of a domain index; (ii) using the domain index to select one or more corresponding linear transformations; (iii) applying one or more of the selected linear transformations on the vector to obtain a resulting vector in a first intermediate space; and (iv) applying a predetermined function on each element of the resulting vector to obtain an output vector in a second intermediate space; and (b) mapping the resulting vectors of the second intermediate space by linear transformation to obtain an output tuple of vectors in R^{N} space. The domain index may be represented by one 2^{k} values, k being an integer. Each selectable linear transformation may be expressed in the form of a matrix. Alternatively, the selectable linear transformations are presented in the form of a single matrix containing all the selectable linear transformations. The domain index may be used to select an appropriate set of linear transformations for operating on the input vectors as well as for obtaining the output vectors.

In the predetermined function of a method according to another embodiment of the present invention, a vector in the second intermediate space may have twice the number of elements as a vector of the first intermediate space. In that embodiment, the predetermined function may provide, when an i-th element of a vector in the first intermediate space has a value x, values 0 and x at the (2*i)-th and the (2*+1)-th positions in the resulting vector of the second intermediate space, respectively, and the values x and 0 in those positions otherwise. Such a function may be used to implement a threshold function.

The present invention is applicable, for example, on programs that are used to perform data prediction. The results from the data prediction may be presented as a probability distribution over a set of candidate results.

The present invention is better understood upon consideration of the detailed description below.

### BRIEF DESCRIPTION OF THE DRAWINGS

FIG. 1 is a block diagram of one implementation of program learning system 100 for learning a target function, according to one embodiment of the present invention.

### DETAILED DESCRIPTION OF THE PREFERRED EMBODIMENTS

The present inventor created two program structures (specifically, a “recognizer” and a “convolutioner”) that are to be used to construct machine-learned programs. These program structures have been disclosed, for example, in the Related Application incorporated by reference above. In the Related Application, the present inventor discloses that the two program structures may be alternately exercised over tuples of vectors of N real numbers (i.e., over space R^{N}), where N is an integer. The vectors are derived from the input data, which may be provided, for example, by a set of vectors over space R^{N}. The parameters of the program structures are adaptively optimized using the training data. As disclosed in the Related Application, the recognizer operates on an input tuple of vectors. In one embodiment disclosed in the Related Application, the recognizer first applies a linear transformation L₀: R^{N}→R^{M}, which maps each vector of the input tuple from an R^{N} space to a R^{M} space, where N and M are integers. Each vector in the input tuple is transformed into a corresponding vector of M elements (i.e., a vector in R^{M}). The recognizer then applies a predetermined function f: R^{M}→R^{M} to each result of the L₀ transformations. The recognizer then applies a linear transformation L₁: R^{M}→R^{N} to each resulting vector in R^{M} to create a vector back in R^{N} space. In this manner, the recognizer filters each input vector to obtain therefrom an output vector representing a desired filtered value.

In the recognizer of the Related Application, the linear transformation L₀ may be achieved by multiplying the vector in R^{N} (a 1×N vector) with a N×M matrix. According to one embodiment of the present invention, an alternative recognizer is provided, in which linear transformation L₀ is achieved using a 2^{k} N×M matrices. The 2^{k} N×M matrices may be represented by a single N×2^{k}M matrix in which the i-th N×M matrix occupies the i-th N rows of the single N×2^{k}M matrix. For example, the i-th matrix of the 2^{k} N×M matrices, i being an integer between 1 and M (i.e., M≧i≧1), may be assigned the M rows in the N×2^{k}M matrix between the ((i−1)*M)-th row to (i*M−1)-th row. In other words, the third matrix is assigned to the M rows between the 2M-th row to the (3M−1)-th row of the single N×2^{k}M matrix. Linear transformation L₀ can then be achieved using two steps. In the first step, the elements of the input vector are mapped into one of 2^{k} values (a “domain index”). In one implementation, the values of the elements of the input vector are used (e.g., concatenated) to form a binary number of k or more bits, and k of those bits are used as the domain index. In the second step of linear transformation L₀, the domain index determines which of the 2^{k} N×M matrices to multiply with the input vector. In this manner, the input vector itself selects a linear transformation appropriate to its value. Such a recognizer structure may facilitate the learning process.

In the Related Application, one example of the predetermined function following linear transformation Lₒ is the threshold function f(x)=0, if x<c, and x, otherwise; where c is a given real number. According to one embodiment of the present invention, rather than the threshold function f: R^{M}→R^{M}, an alternative function g: R^{M}→R^{2M} is applied. Alternative function g maps each element in the output vector of linear transformation L₀ to two corresponding values. In other words, function g transforms a vector in R^{M} space to a vector in R^{2M} space. For example, function g may map the i-th element of the input vector in R^{M} space, M−1≧i≧0, to the values at the (2*i)-th and the (2*i+1)-th positions in the output vector in R^{2M} space. In one implementation, if the i-th element has a positive value x, function g provides the values 0 and x at the (2*i)-th and (2*+1)-th positions in the output vector (in R^{2M} space), respectively, and the values x and 0 in those positions otherwise.

According to this embodiment, linear transformation L₁ would transform the 2M results from function g back to an output vector of N elements (i.e., L₁: R²M→R^{N}). An arrangement similar to linear transformation L₀—in that one of 2^{k} transformation matrices (or a corresponding portion of a single 2^{k+}1M×N matrix) is selected using the same or another domain index—may also be used to carry out linear transformation L₁. In conjunction with linear transformation L₁, the exemplary implementation for function g may be seen as a generalization of the threshold function. In that embodiment, to implement the threshold function, for example, linear transformation L₁ operates only on the (2*i)-th values of the vector in R^{2M} space.

FIG. 1 is a block diagram of one implementation of program learning system 100 for learning a target function, according to one embodiment of the present invention. In this description, merely by way of example, the target function is the text prediction function described above performed over training data consisting of a corpus of documents. However, many other suitable applications are possible and within the scope of the present invention. As shown in FIG. 1, program learning system 100 includes learning program 101, which implements the target function to be learned. Learning program 101 receives input vector 104 from the training data and model parameter values 107 to provide output vector 105. Input vector 104 may include, for example, the textual search query. Output vector 105 is, for example, a “best next word” probability distribution computed by learning program 101 based on model parameter values 107 over the documents in the training data. Integrated into learning program 101 is stochastic gradient descent module 102 which carries out evaluations of the loss or error function and the gradient vector 106 for the loss or error function with respect to model parameters values 107. One possible implementation of stochastic gradient descent module 102, which uses the Newton's method in conjunction with a method of conjugate residuals to obtain output vector 105 and gradient vector 106, is described, for example, in the copending U.S. patent application Ser. No. 14/165,431, entitled “Method for an Optimizing Predictive Model using Gradient Descent and Conjugate Residuals,” filed on Jan. 27, 2014. The disclosure of the '431 patent application is hereby incorporated by reference in its entirety. Output vector 105 and gradient vector 105 are then provided to parameter update module 103. Updated parameter values 107 are fed back into configuring learning program 101.

Learning program 101 may be implemented in a computational environment that includes a number of parallel processors. In one implementation, each processor may be a graphics processor, to take advantage of computational structures optimized for arithmetic typical in such processors. Control unit 108 (e.g., a host computer system using conventional programming techniques) may configure the computational model for each program to be learned.

As shown in FIG. 1, learning program 101 may be organized, for example, to include control program structure 151, recognizer 152, predetermined function 153, convolutioner 154 and output processing program structure 155. Control program structure 151 configures recognizer 152, predetermined function 153 and convolutioner 154 using model parameter values 107 and control information from control unit 108 and directs data flow among these program structures. Recognizer 152, predetermined function 153, and convolutioner 154 may be implemented according to the detailed description above. Output processing program structure 155 may perform, for example, normalization and exponentiation of the post-convolution vectors to provide the probability distribution of the “next word” to be predicted.

As mentioned in the Related Application, programs of the present invention are useful in various applications, such as predicting stock market movements, building language models, and building search engines based on words appearing on a page and through use of a likelihood function.

The above detailed description is provided to illustrate specific embodiments of the present invention and is not intended to be limiting. Many modifications and variations within the scope of the present invention are possible. The present invention is set forth in the following claims.

I claim:

1. In a recognizer program structure of a program that is learned over training data, the recognizer program structure receiving an input tuple of vectors in R^{N} space, N being an integer, a method comprising:
for each vector in the input tuple of vectors:
mapping the vector to one of a domain index;
using the domain index to select a corresponding linear transformation;
applying the selected linear transformation on the vector to obtain a resulting vector in a first intermediate space; and
applying a predetermined function on each element of the resulting vector to obtain an output vector in a second intermediate space; and
mapping the resulting vectors of the second intermediate space by linear transformation to obtain an output tuple of vectors in R^{N} space.

2. The method of claim 1, wherein the domain index is represented as one of a predetermined number of values which is a power of two.

3. The method of claim 1, wherein the corresponding linear transformation is selected from a predetermined number of linear transformations.

4. The method of claim 3, wherein each of the linear transformations is expressed in the form of a matrix.

5. The method of claim 3, wherein the linear transformations are presented in the form of a single matrix.

6. The method of claim 1, wherein a vector in the second intermediate space has twice the number of elements as a vector of the first intermediate space.

7. The method of claim 6, wherein the predetermined function provides, when an i-th element of a vector in the first intermediate space has a positive value x, values 0 and x at the (2*i)-th and the (2*+1)-th positions of the resulting vector in the second intermediate space, respectively, and the values x and 0 in those positions otherwise.

8. The method of claim 7, wherein the predetermined function represents a threshold function.

9. The method of claim 1, wherein the first intermediate space and the second intermediate space are the same.

10. The method of claim 1, mapping the resulting vectors in the second intermediate space comprises selecting a second corresponding linear transformation using the domain index.
